(19) United States
(12) Patent Application Publication
(10) Pub. No.: US 2026/0032321 A1
(43) Pub. Date: Jan. 29, 2026

(54) CUSTOMIZED TRICK PLAY WITH DYNAMIC THUMBNAIL MODIFICATION

(71) Applicant: VIDANGEL ENTERTAINMENT, INC., Lehi, UT (US)

(72) Inventors: Blake VANDEMERWE, Lehi, UT (US); Jarom MCDONALD, Lehi, UT (US); Jason BODILY, Lehi, UT (US)

(21) Appl. No.: 19/282,944

(22) Filed: Jul. 28, 2025

Related U.S. Application Data
(60) Provisional application No. 63/676,812, filed on Jul. 29, 2024.

(51) Int. Cl. H04N 21/81; H04N 21/44; H04N 21/472

(52) U.S. Cl. CPC H04N 21/81; H04N 21/44008; H04N 21/47217

(57) ABSTRACT

Disclosed embodiments are directed to systems and methods for enhancing the trick play experience on a digital media player. Systems identify a triggering event to activate a trick play mode, access a set of thumbnails associated with a media file for display during trick play, and retrieve streaming criteria to exclude specific content during streaming. The method dynamically modifies a thumbnail containing targeted content based on the streaming criteria, ensuring the exclusion of the targeted content. Upon user selection to preview content of a media file at a specific temporal location in the media file, the modified thumbnail is displayed, providing a customized trick play experience that optimizes user interaction with the media file.

### CROSS-REFERENCE TO RELATED APPLICATION

This application claims the benefit and priority of U.S. Provisional Patent Application Ser. No. 63/676,812, filed on 29 Jul. 2024, entitled “CUSTOMIZED TRICK PLAY EXPERIENCE METHOD WITH DYNAMIC THUMBNAIL MODIFICATION,” and which application is expressly incorporated herein by reference in its entirety.

### BACKGROUND

Current methods for providing trick play experiences in digital media players typically involve basic functionalities such as fast forward, rewind, pause, and play. These functionalities allow users to navigate through media content at different speeds or pause the content for a closer examination. However, while there are some methods for customizing the playback or streaming experience for media files, in conventional trick play modes users may encounter unwanted or targeted content while navigating through media files, leading to a less-than-ideal viewing experience.

Thumbnails are often static representations of specific temporal locations within a media file and may reflect unwanted content at that moment. As a result, users may inadvertently encounter targeted content when previewing media content using thumbnails. This limitation hinders the ability to provide a seamless and personalized trick play experience that aligns with user preferences and streaming criteria.

Accordingly, there is an ongoing need and desire for improved methods and systems for providing a customized trick play experience that addresses these limitations of conventional trick play modes.

### SUMMARY

Disclosed embodiments include systems and methods for providing a customized trick play experience for users. Some disclosed embodiments are directed to systems and methods for providing a clean or filtered trick play experience in accordance with a positive playback experience associated with a digital media player.

In some aspects, the disclosed embodiments described herein relate to a method for providing a customized trick play experience by modifying an existing thumbnail set. For example, systems identify a triggering event that triggers the activation of a trick play mode of a digital media player. In response to identifying the triggering event, systems access a set of thumbnails associated with a media file, the set of thumbnails configured to be displayed as part of a trick-play mode of the digital media player and access a set of streaming criteria that defines targeted content that should not be displayed while using the digital media player to stream the media file.

Based on the set of streaming criteria, systems identify a thumbnail included in the set of thumbnails that includes the targeted content defined by the set of streaming criteria. The thumbnail is associated with a particular temporal location in the media file. In response to identifying the thumbnail included in the set of thumbnails that includes targeted content, systems dynamically modify the thumbnail so that the thumbnail does not include targeted content. Systems then identify a user selection to preview the content of the media file at the particular temporal location in the media file. In response to identifying the user selection, systems display the modified thumbnail during the user selection to preview the content of the media file at the particular temporal location in the media file.

In some aspects, the disclosed embodiments described herein relate to a method for providing a customized trick play experience by generating customized thumbnails. For example, systems identify a triggering event that triggers an activation of a trick play mode of a digital media player for a media file. In response to identifying the triggering event, systems access a set of streaming criteria that defines targeted content that should not be displayed while using the digital media player to stream the media file.

Next, systems generate a set of thumbnails associated with a media file based on the set of streaming criteria. The set of thumbnails is configured to be displayed as part of a trick-play mode of the digital media player. Systems then identify a user selection along a progress bar to preview the content of the media file at one or more temporal locations in the media file. In response to identifying the user selection, systems display one or more thumbnails from the set of thumbnails during the user selection to preview the content of the media file at the one or more temporal locations in the media file.

This Summary is provided to introduce a selection of concepts that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of the subject matter briefly described above will be rendered by reference to specific embodiments that are illustrated in the appended drawings. Understanding that these drawings depict only typical embodiments and are not, therefore, to be limiting in scope, embodiments will be described and explained with additional specificity and detail through the use of the accompanying drawings in which:

FIG. 1 illustrates an example embodiment of a user interface associated with a digital media player.

FIG. 2 illustrates an example embodiment of a set of thumbnails used as part of a trick play mode associated with the digital media player of FIG. 1.

FIG. 3A illustrates an example embodiment of a process flow diagram for accessing a conventional set of thumbnails for a media file to be used in a trick play functionality of a digital media player.

FIG. 3B illustrates an example embodiment of a process flow diagram for generating a conventional set of thumbnails to be used in a trick play functionality of a digital media player.

FIG. 4 illustrates an example embodiment of a process flow diagram for providing a customized trick play experience by applying a universal filter to the set of thumbnails prior to storing the set of thumbnails.

FIG. 5 illustrates an example embodiment of a process flow diagram for providing a customized trick play experience by applying a universal filter to the set of thumbnails prior to displaying any of the thumbnails on a user display.

FIG. 6 illustrates an example embodiment of a process flow diagram for providing a customized trick play experience by applying a user filter to the set of thumbnails prior to displaying any of the thumbnails on a corresponding user display.

FIG. 7 illustrates an example embodiment of a process flow diagram for generating a set of thumbnails based on generation criteria.

FIG. 8 illustrates various example embodiments of different generation criteria.

FIGS. 9-10 illustrate various example embodiments of process flow diagrams for identifying targeted content in thumbnails.

FIG. 11 illustrates an example embodiment of a global fingerprint index.

FIGS. 12A-12G illustrates various examples of different embodiments of thumbnail sets associated with a media file that is generated, modified, or filtered according to the disclosed embodiments herein.

FIG. 13 illustrates an example of a process flow diagram associated with a plurality of acts of a method for providing a customized trick play experience.

FIG. 14 illustrates another example of a process flow diagram associated with a plurality of acts of a method for providing a customized trick play experience.

FIG. 15 illustrates an example computing environment in which a computing system incorporates and/or is utilized to perform disclosed aspects of the disclosed embodiments.

### DETAILED DESCRIPTION

Disclosed embodiments include systems and methods that may be utilized for providing a customized trick play experience for users.

The disclosed embodiments may be utilized to realize many technical benefits and advantages over conventional systems and methods for providing such trick play experiences by allowing users to determine what types of content are included in thumbnails displayed while digitally scrolling through a media file. For example, the disclosed embodiments beneficially provide systems and methods that are able to customize a trick play mode of a digital media player for different users based on personalized user streaming criteria. In this manner, systems are able to provide a trick play experience that matches a positive playback or streaming experience associated with a media file in the digital media player.

In some instances, where a universal filter is applied to an existing set of thumbnails, systems are able to save on storage capacity requirements by only storing thumbnails that will contribute to the positive and customized trick play experience for a user, thereby saving on processing costs. Additionally, by identifying specific thumbnails that comprise unwanted targeted content, the system is able to modify only those thumbnails that comprise the unwanted targeted content, also saving on system processing costs.

On the other hand, if a system is configured to dynamically generate thumbnails for trick play on demand, systems are able to save on long-term storage requirements by generating and caching thumbnails for a limited time during the user access to the media file. By generating the thumbnails according to the generation criteria, the system also saves on processing costs related to subsequent filtering out or modification of thumbnails in order to tailor the trick play experience for a particular user.

It should be appreciated that customized trick play experiences improve the overall user experience by preventing the user from being exposed to potentially offensive or triggering content that may cause emotional distress, especially if the user has already provided configuration settings for what types of content they would like to encounter during the use of the digital media player.

Additionally, existing digital media players cannot identify triggering events that prompt the activation of a trick play mode and subsequently modify thumbnails to ensure a seamless viewing experience. Without the ability to dynamically adjust thumbnails based on streaming criteria and user preferences, users may be exposed to unwanted content during the previewing process.

With regard to the use of the term thumbnail, it is noted that thumbnails can be interpreted in the art to include both (i) a temporal set of images extracted from a video file and stored in memory, or (ii) an ephemeral set of image references selected for a viewing experience, which are generated on the fly and not permanently stored. In preferred embodiments, the referenced thumbnails are ephemeral images that are derived from the images of the video file.

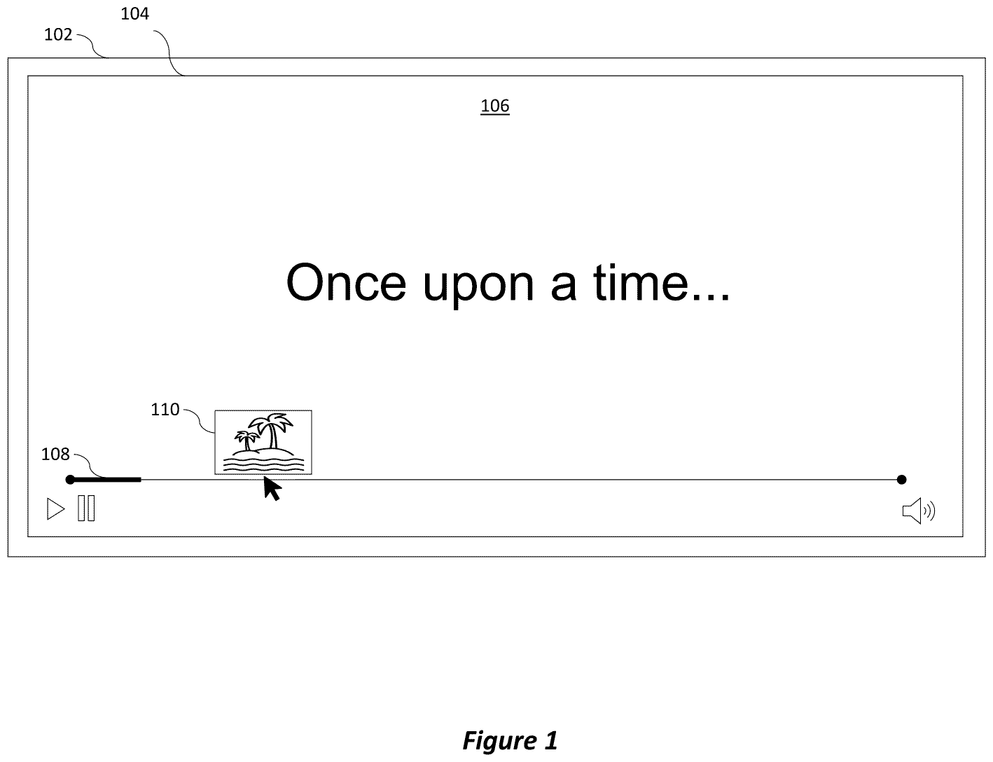

Attention will now be directed to FIG. 1, which illustrates an example user interface streaming an audio-visual media file. For example, a user device 102 is shown comprising a display screen 104. The display screen is configured to display a media file that is being streamed through a streaming service or application on the user device 102. The media file could comprise an audio file (e.g., music, podcast, or other audio recording), an image or series of images (e.g., slideshow), or a video (e.g., movie, television show, news recording, user-generated content, etc.) The display screen 104 is shown illustrating an opening scene 106 associated with the media file. The opening scene comprises the text “Once upon a time . . . ” as shown being displayed on the user interface.

The user interface also comprises a play button, a pause button, and a volume control button. The user interface also comprises a video progress bar 108 that is also configured as a seek or scroll bar that allows a user to both view how far into the media file they have watched, as well as drag the cursor across the seek/scroll bar to fast forward, rewind, seek or scroll to a particular temporal location within the media file. This functionality is often referred to as a trick mode or trick play of a digital video service. It provides visual feedback to the user while scrolling through the media file or facilitating user-controlled selection of the temporal location of the media file. The use of the video progress bar 108 in trick mode is often accompanied by a thumbnail display (e.g., thumbnail image 110) that depicts an image of the content included in the media file at a particular temporal location as a preview of the content for that scene.

For example, when the user hovers the cursor over a particular spot along the video progress bar 108, the thumbnail image 110 is displayed, which depicts a tropical scene associated with that particular temporal location in the media file. Often the thumbnails are generated or derived from one or more frames of the audio-visual file. These thumbnail displays are particularly useful for aiding a user in locating the desired portion of content within the media file to begin playing the media file again. For example, a user may want to pick up from where they left off previously, skip a certain portion of content, skim through a particular portion of content, or skip over (i.e., scroll, seek, etc.) to a specific portion of content.

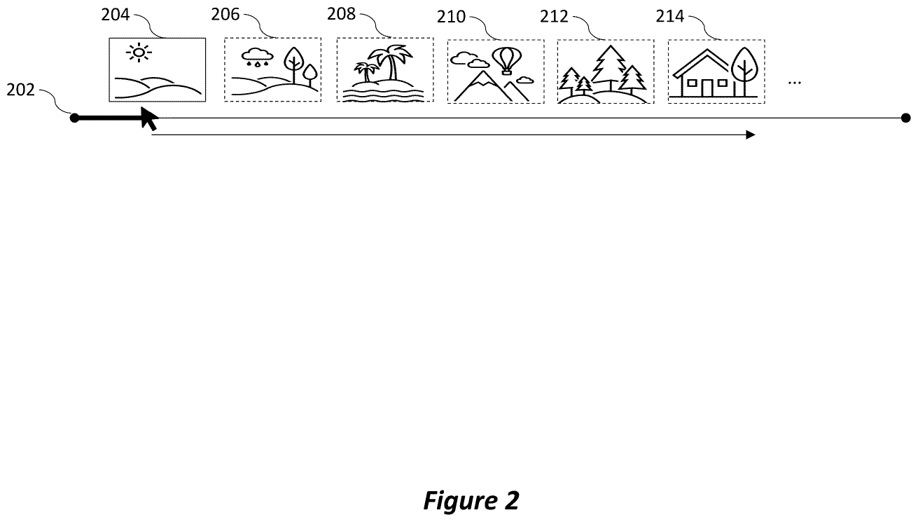

By scrolling through the various thumbnails, the user is able to identify specific points along the video progress bar 108 that are associated with the various thumbnails being displayed. As shown in FIG. 2, as a user moves and hovers the cursor across the video progress bar 202, different thumbnails are displayed. For example, at the current temporal location (as indicated by the bolded portion of the video progress bar 202, thumbnail image 204 is displayed above the cursor. As the user moves the cursor (as indicated by the line and arrow pointing towards the end of the video progress bar 202), additional thumbnails are displayed (e.g., thumbnail image 206, thumbnail image 208, thumbnail image 210, thumbnail image 212, thumbnail image 214, and so on . . . ). Conventional trick play thumbnails are generated from the content at scene breaks or consistent intervals. These thumbnails can be generated before streaming or playback of a media file and included as part of the metadata for the media file to be called by the trick play functionality of the media service. Alternatively, the thumbnails can be generated in response to receiving a request to play or stream a particular media file so that the thumbnails are able to be temporally cached during viewing/listening of the media file.

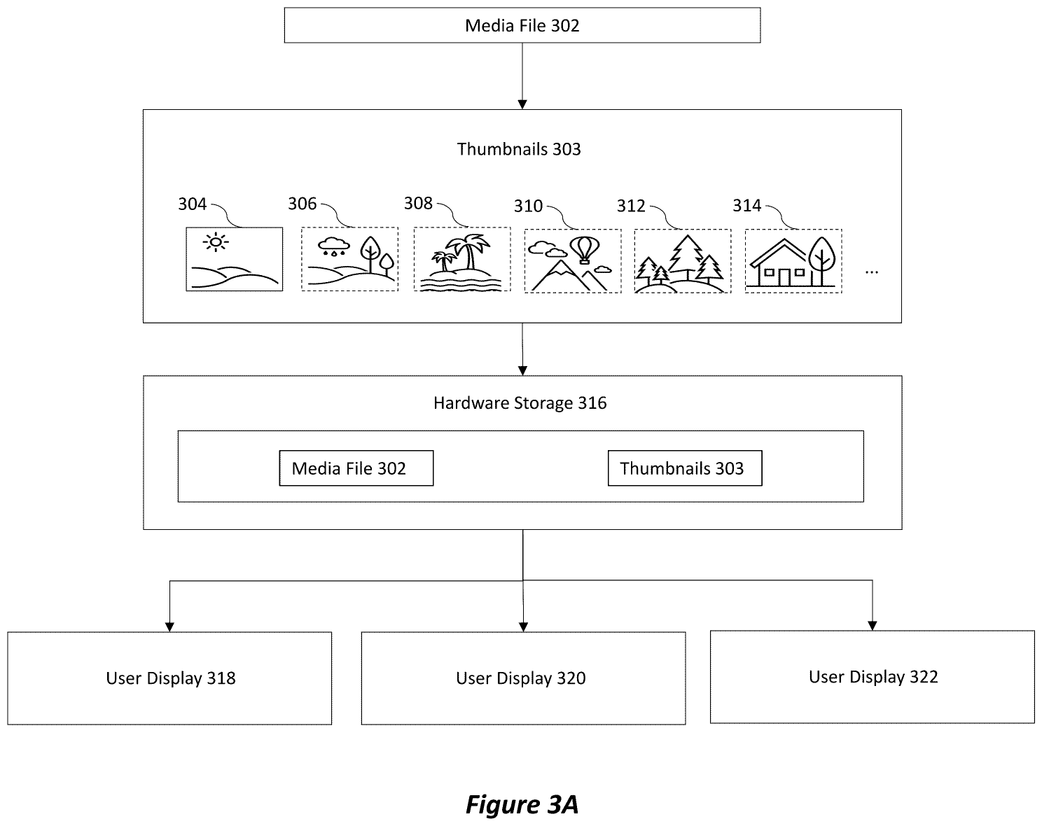

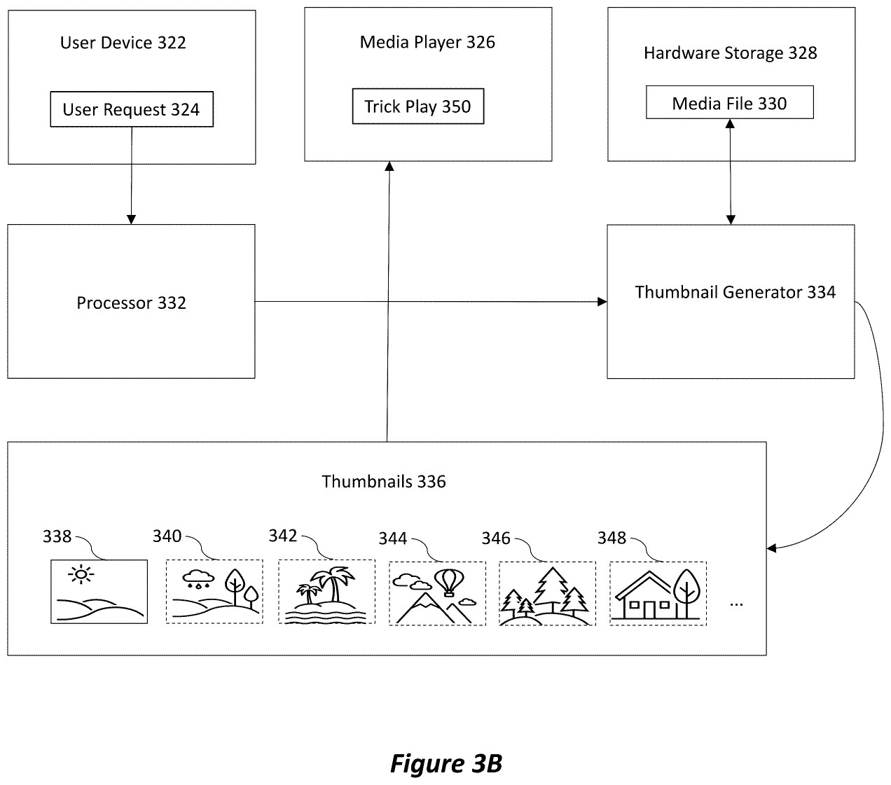

As briefly mentioned previously, there are several different methods for generating thumbnails of the media file to use as part of the trick play functionality. For example, as shown in FIG. 3A, in some instances, a fixed set of thumbnails 303 is generated or derived from a media file 302. These can be generated at scene breaks, at specific time intervals, or some other metric that provides a series of sequential images to be used as thumbnails. In some instances, one or more of the thumbnails may be from consecutive frames of the media file. The media file 302 is associated with thumbnails 303. In some instances, the derived thumbnails 303 are stored locally, on a remote server, or in cloud servers (e.g., hardware storage 316), along with the associated media file 302, and subsequently can be accessed by a plurality of different users (e.g., user display 318, user display 320, user display 322, etc.) to be displayed when the trick mode of their media player is activated/used for the media file 302.

Alternatively, in some instances, the thumbnails are merely ephemeral and generated in real-time or in response to receiving a user request to access the media file. For example, as shown in FIG. 3B, a user device 322 receives a user request 324 to access media file 330 stored in hardware storage device 328. A processor 332 communicates the user request 324 to the thumbnail generator 334, which is able to access the media file 330 and generate a set of thumbnails 336 (e.g., thumbnail 338, thumbnail 340, thumbnail 342, thumbnail 344, thumbnail 346, thumbnail 348, and so on . . . ). The set of thumbnails 336 is then used to provide trick play functionality (e.g., trick play 350) within the media player 326.

However, in either case, sometimes the media file may contain content such as audio, images, or scenes, which comprise certain categories of targeted content that may be offensive or triggering to a user. While some platforms provide warnings, visual or auditory censoring, or other customizable filtering/playback functionality to avoid viewing such content in the media file, oftentimes the thumbnails generated for those scenes may still be displayed as part of the trick play functionality in response to using the video progress bar 108 to scroll through the media file.

In light of this issue, the disclosed embodiments beneficially provide systems and methods for facilitating a customizable trick play during media file playback and streaming. The disclosed systems and methods ensure that the visual cues provided to users when seeking, rewinding, or fast-forwarding only reflect those portions of the media file that the user intends to see.

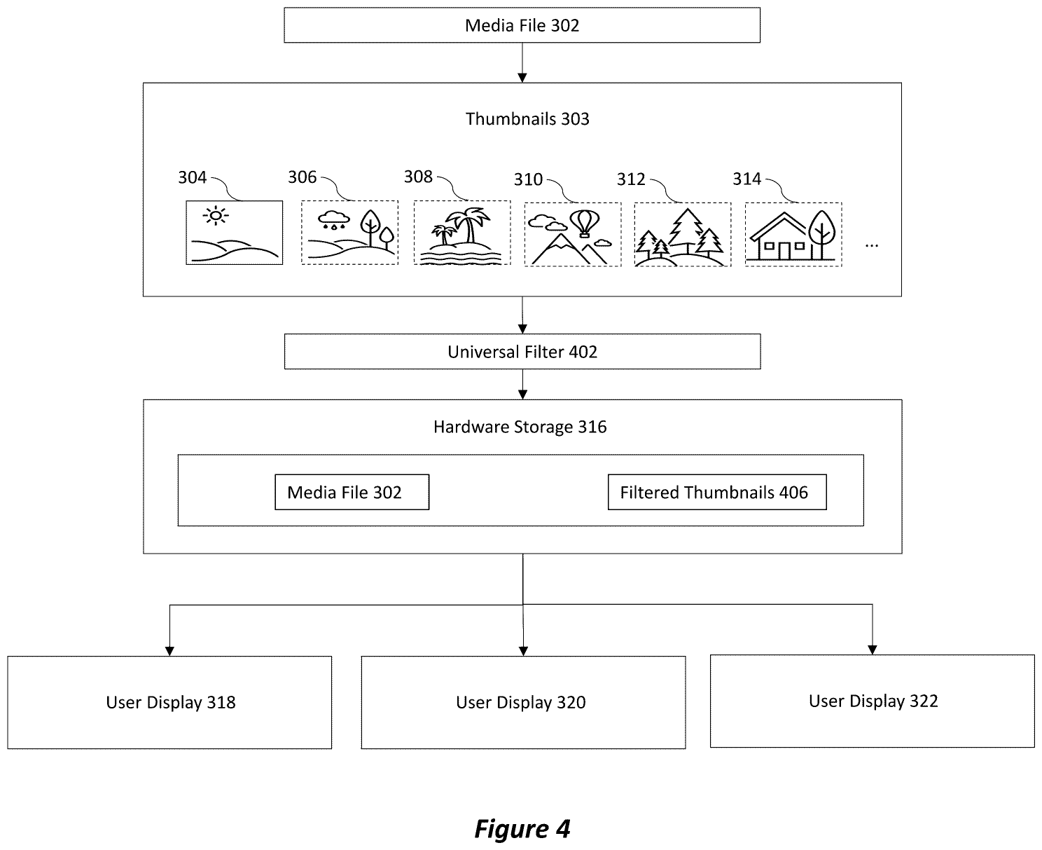

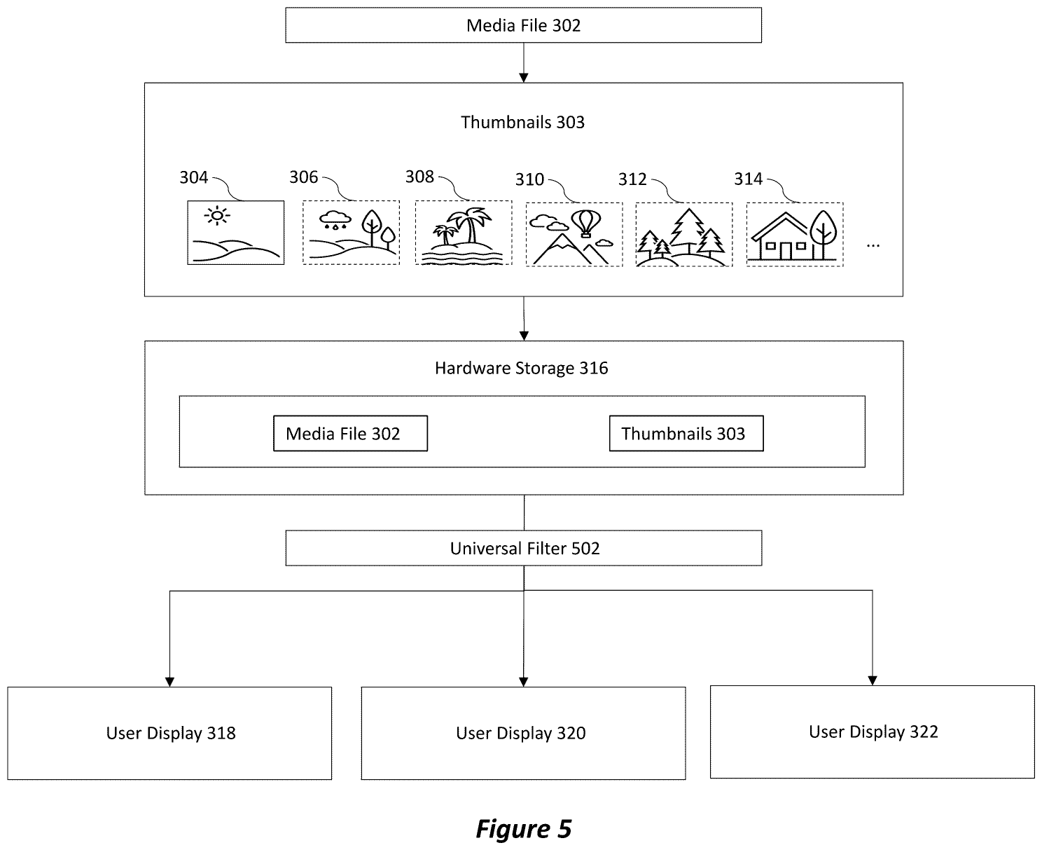

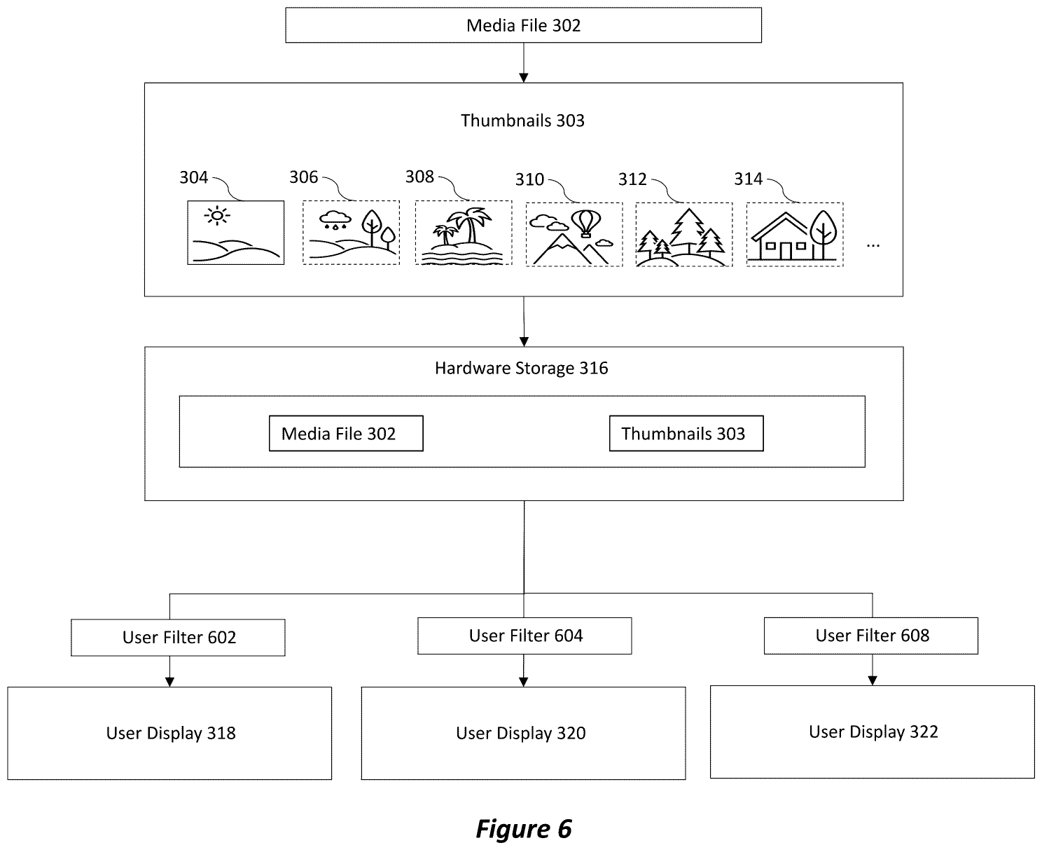

In some embodiments, a set of visual cues is generated, filtered, and subsequently used by all users as a set of universal thumbnails as part of the trick play functionality, wherein the thumbnails that are displayed on user devices do not comprise any content that may be offensive or triggering under any of the previously identified categories, tags, warnings, or filtering available through the media streaming platform. This filtering can occur as a universal filter after the generation of a first set of thumbnails (see, FIG. 4), as a universal filter when the stored thumbnails are called as part of the trick play functionality of a user device (see, FIG. 5), as a user-specific filter when the stored thumbnails are called as part of the trick play functionality (see, FIG. 6), or a combination thereof.

Attention will now be directed to FIG. 4, which illustrates one example embodiment for providing a customized trick play experience. For example, as shown in FIG. 4 (which comprises some previously illustrated components of FIG. 3A), a set of thumbnails 303 is generated for media file 302. This set of thumbnails 303 is then filtered according to a universal filter 402 which is configured to identify targeted content according to one or more filtering criteria and modify the set of thumbnails to discard, replace, or modify any thumbnails that correspond to the targeted content that is designated to be filtered out. This filtered set of thumbnails (e.g., filtered thumbnails 406) is now stored in hardware storage 316 (e.g., system cache) and is associated with the media file 302 with media index data structures of a media player, for example, (not shown). The filtered thumbnails 406 are then used for any trick play functionality invoked on any of the user devices (e.g., user display 318, user display 320, user display 322, etc.).

Attention will now be directed to FIG. 5, which illustrates an alternate example embodiment for providing a customized trick play experience. For example, as shown in FIG. 5 (which also comprises various components previously illustrated in FIG. 3A), a set of thumbnails (e.g., thumbnails 303) is generated for media file 302 and stored in hardware storage 316. Then, when the system receives a user request to access the media file 302 and its corresponding thumbnails (e.g., thumbnails 303), the system employs a universal filter 502, such that only thumbnails that meet the filtering criteria set by the universal filter are transmitted/displayed on the various user devices (e.g., user display 318, user display 320, user display 322, etc.).

Attention will now be directed to FIG. 6, which illustrates another example embodiment for providing a customized trick play experience. In some embodiments, the set of thumbnails is generated as customized thumbnails based on a user's specific criteria. For example, as shown in FIG. 6 (which also comprises some components previously illustrated and described in FIG. 3A), thumbnails 303 are generated for media file 302 and stored in hardware storage device 316. When the system receives a user request to access the media file 302 and its corresponding thumbnails 303, the system accesses a user filter (e.g., user filter 602, user filter 604, user filter 608) that corresponds to the user display from which the user request originated. For example, user filter 602 corresponds to user display 318, user filter 604 corresponds to user display 320, and user filter 608 corresponds to user display 322. The system applies the corresponding user filter on thumbnails 303, such that only thumbnails that meet the filtering criteria set by the user filter are transmitted/displayed on the various user devices.

These user-defined filtering criteria included as part of the user filter may comprise profile-based user-defined settings that apply to any media that is accessed through the media streaming platform, user-defined settings that apply to a particular media file, or a combination thereof. The user may also determine whether the profile-based user-defined settings or the user-defined setting for a particular media file are selected if there is a conflict between either version of the settings for a particular portion of content. Thus, the thumbnails are filtered according to the user's specific criteria for what types of content they intend to view and/or desire to avoid viewing.

For example, a user may define settings for certain targeted content to be avoided, such as violence, offensive language, nudity, sexual activity, reference or depiction of drugs/using drugs, graphic injuries, or other categories. Users may also define more granulated sub-categories for one or more of the aforementioned categories. In some instances, these categories or sub-categories of targeted content correspond to various tags or fingerprints associated with the media file.

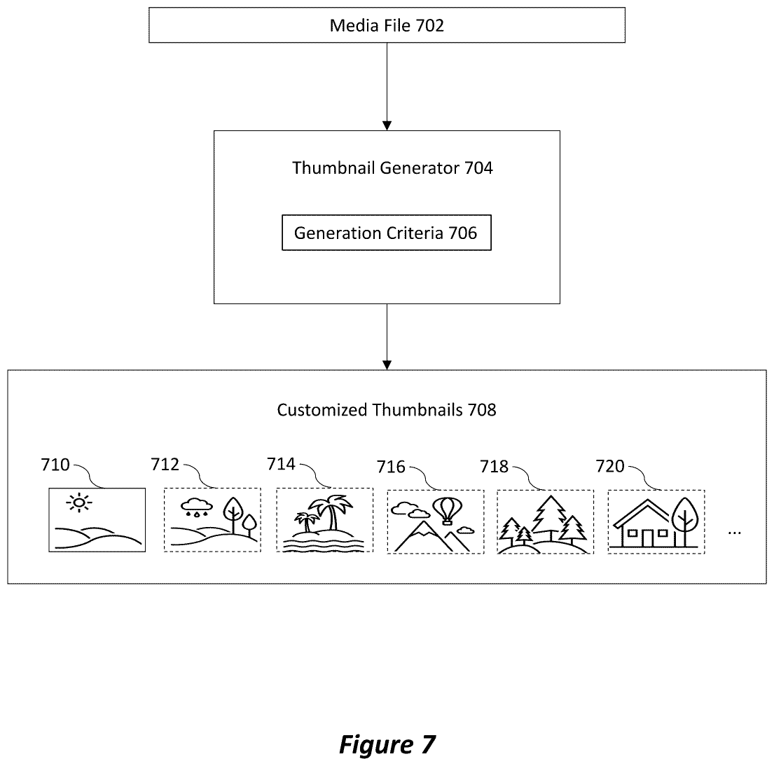

As described previously in conjunction with FIG. 3B, in some instances, the thumbnails are generated in real-time or in response to receiving a request to access, display, or stream the media file. Thus, some disclosed embodiments are described herein to provide an improved thumbnail generation process. Attention will now be directed to FIG. 7, which illustrates a thumbnail generator 704 that is configured according to generation criteria 706. This generation criteria 706 is similar to, and in some instances, representative of, the filtering criteria associated with the universal filters and user filters described in FIGS. 4-6. However, instead of the filtering criteria being used to filter or modify existing thumbnails, the filtering criteria are configured as generation criteria that are used to modify the thumbnail generation process. It should be appreciated that in some instances, thumbnail generator 704 is configured as an image extractor that identifies frames in the media file that meet the generation criteria and extracts the corresponding frame as the thumbnail for a portion of the media file. Alternatively, in some instances, the thumbnail generator 704 is configured as a machine learning model whose generation parameters have been configured according to the generation criteria 706.

For example, as shown in FIG. 7, in response to receiving a request to access media file 702, media file 702 is provided as input to thumbnail generator 704. The thumbnail generator then uses the generation criteria 706 to generate a set of customized thumbnails 708 (e.g., thumbnail 710, thumbnail 712, thumbnail 714, thumbnail 716, thumbnail 718, thumbnail 720, and so on . . . ) that will be displayed when the user is interacting with the trick play functionality on the user interface of their media player/user device.

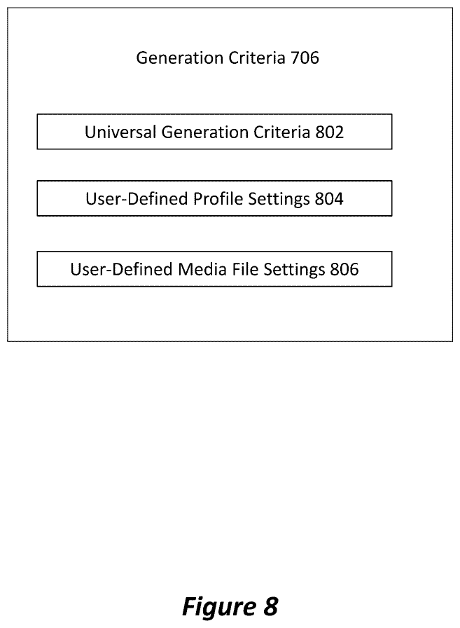

Attention will now be directed to FIG. 8, which illustrates various example embodiments of the generation criteria 706. For example, in some instances, the generation criteria 706 is based on universal generation criteria 802 which will only generate thumbnails that meet the generation criteria across all pre-defined categories of targeted content. Thus, thumbnails generated based on this universal generation criteria 802 will be suitable for all users, regardless of varying personal preferences, as it will be a set of thumbnails least likely to contain any content that might be considered offensive or triggering. It should be appreciated that the set of thumbnails generated based on the universal generation criteria 802 may be generated in response to receiving a request to access a particular media file, or alternatively, may be generated previous to a request and stored along with the media file, as previously described.

In some instances, the generation criteria 706 is based on user-defined profile settings 804, which are configured to be applied to any media file that is accessed through the corresponding user profile. In some instances, the profile settings are configured as parental settings or manager/employer settings that define criteria for multiple user profiles. Additionally, or alternatively, the generation criteria 706 is based on user-defined generation criteria that are specific to a particular media file (e.g., User-Defined Media File Settings 806). In some instances, the generation criteria 706 is based on a combination of the universal generation criteria 802, user-defined profile settings 804, and user-defined media file settings 806. The system is configurable to employ a priority system to determine which source of generation criteria to weigh more heavily or which source of generation criteria to use in the event of conflicting settings (e.g., the user-defined profile settings may set generation criteria of no violence, while the user-defined media file settings 806 may define generation criteria of only no gun violence-which may allow for other types of violent content to be viewed).

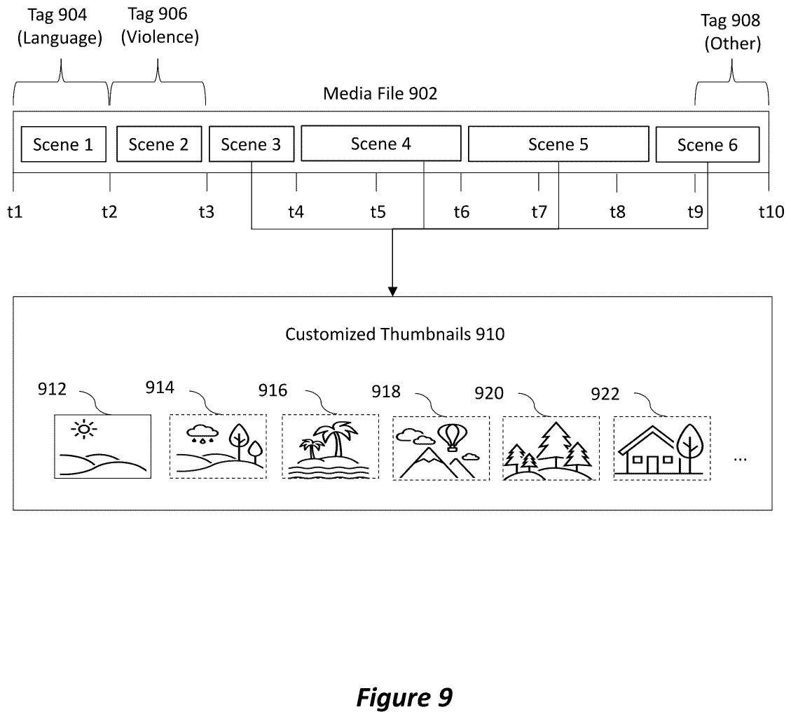

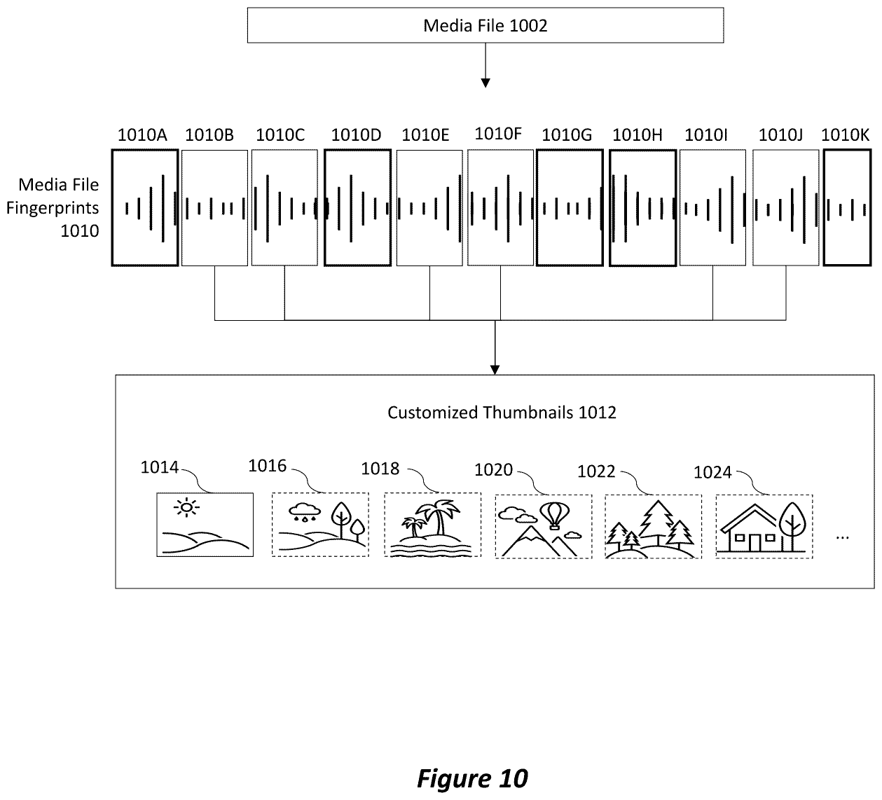

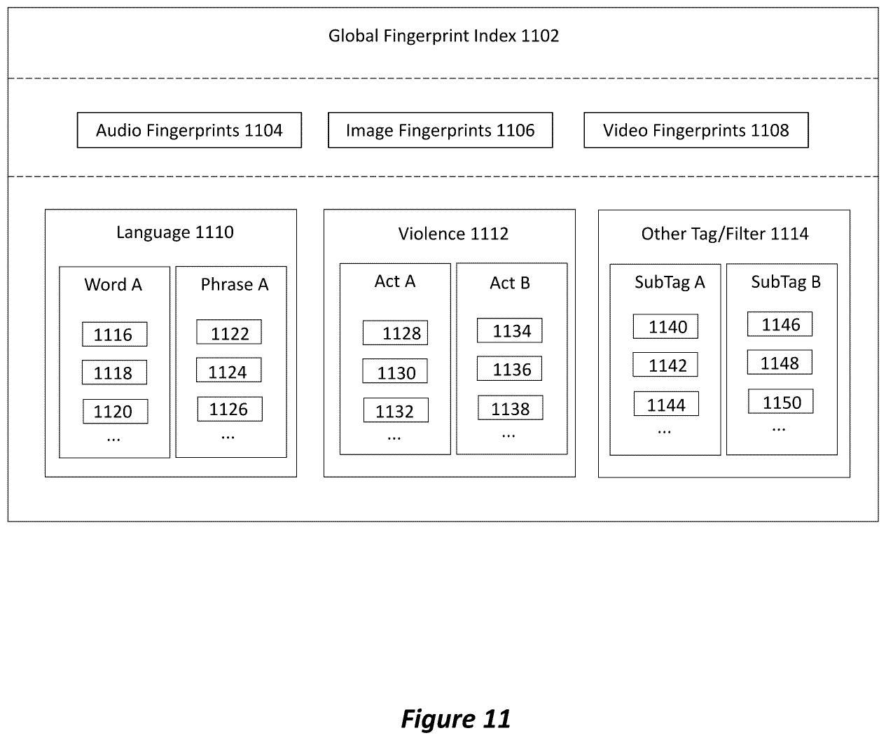

It should be appreciated that either the filtering/modification of existing thumbnails or the generation of new thumbnails is facilitated by identifying targeted content in the media file. This targeted content can be identified using various different methods. For example, in some instances, the media file may have been previously tagged with various tags associated with distinct categories or sub-categories of targeted content (see, FIG. 9). Alternatively, the media file may correspond to fingerprints (or data structures representing intrinsic attributes of the content included in the media file) that have been identified as either containing targeted content or not containing targeted content (see, FIG. 10-11).

Attention will now be directed to FIG. 9, which illustrates a media file (e.g., media file 902) that has been tagged with various tags (e.g., tag 904, tag 906, tag 908) associated with different categories of targeted content (e.g., tag 904 is associated with offensive language, tag 906 is associated with violence, tag 908 is associated with other categories). In the context of filtering, the universal filters and/or user filters are employed based on identifying the portions of the media file that have tags that do not meet the filtering criteria and filtering out any thumbnails that correspond to those portions of the media file. In this manner, undesired content is not present in the thumbnail display during the trick play interaction.

In the context of generation, the system identifies portions of the media file 902 that do not have a tag, or that do not have a tag that matches a category of targeted content to be filtered out. The system then only provides those identified portions of the media file 902 to the thumbnail generator to generate a set of customized thumbnails 910 (e.g., thumbnail 912, thumbnail 914, thumbnail 916, thumbnail 918, thumbnail 920, thumbnail 922, and so on . . . ). By only using those identified portions of the media file that either are not tagged or are not tagged with a tag that matches a pre-defined category of targeted content that should be avoided, the thumbnails that are generated are more likely to exclude any targeted content.

Attention will now be directed to FIG. 10, which illustrates a media file (e.g., media file 1002) that is associated with a set of fingerprints (e.g., media file fingerprints 1010). These media file fingerprints 1010 comprise fingerprints that have been identified to include targeted content (e.g., fingerprint 1010A, fingerprint 1010D, fingerprint 1010G, fingerprint 1010H, and fingerprint 1010K) and fingerprints that have been identified to not include any unwanted targeted content (e.g., fingerprint 1010B, fingerprint 1010C, fingerprint 1010E, fingerprint 1010F, fingerprint 10101).

The system then only provides those identified portions of the media file 902 to the thumbnail generator to generate a set of customized thumbnails 1010 (e.g., thumbnail 1014, thumbnail 1016, thumbnail 1018, thumbnail 1020, thumbnail 1022, thumbnail 1024, and so on . . . ). By only using those identified portions of the media file that are associated with a fingerprint representing targeted content that matches a pre-defined category of targeted content that should be avoided, the thumbnails that are generated are more likely to exclude any targeted content.

In some instances, a global fingerprint index 1102 is utilized in order to identify targeted content in the media file and/or thumbnails. For example, the global fingerprint index 1102 includes audio fingerprints 1104, image fingerprints 1106, and/or video fingerprints 1108. Some sample categories of targeted content include language 1110, violence 1112, or other tag/filter 1114. The category for language 1110 may include one or more words (e.g., Word A) associated with one or more fingerprints (e.g., fingerprint 1116, fingerprint 1118, fingerprint 1120, etc.) that represent Word A or one or more phrases (e.g., Phrase A) associated with one or more fingerprints (e.g., fingerprint 1122, fingerprint 1124, fingerprint 1126, etc.) that represent Phrase A. The category for violence 1112 may include one or more acts (e.g., Act A, Act B, etc.) associated with one or more fingerprints (e.g., fingerprint 1128, fingerprint 1130, fingerprint 1132, etc. for Act A; fingerprint 1134, fingerprint 1136, fingerprint 1138, etc. for Act B). Additional categories for other tags and filters may comprise a plurality of different subtags and associated fingerprints. For example, SubTag A is associated with fingerprint 1140, fingerprint 1142, fingerprint 1144, etc., and SubTag B is associated with fingerprint 1146, fingerprint 1148, fingerprint 1150, etc. The fingerprints associated with the tag/filter or subtag can include audio, image, and/or video fingerprints that are used to facilitate the identification of content (in the media file prior to thumbnail generation or in thumbnails that have already been generated) that corresponds to the tag/filter or subtag.

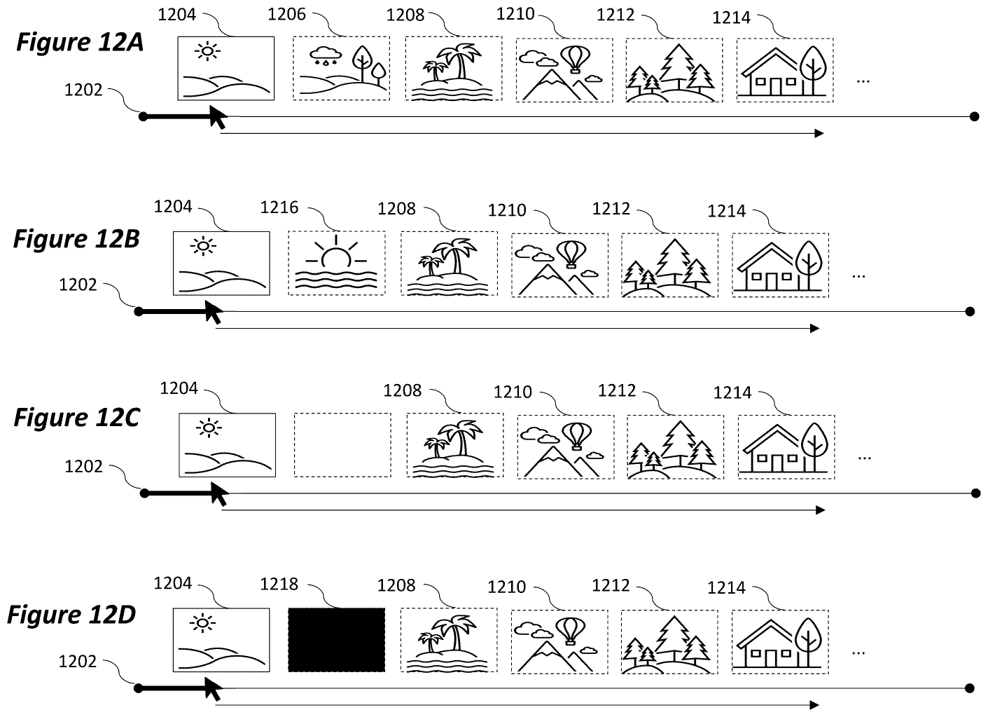

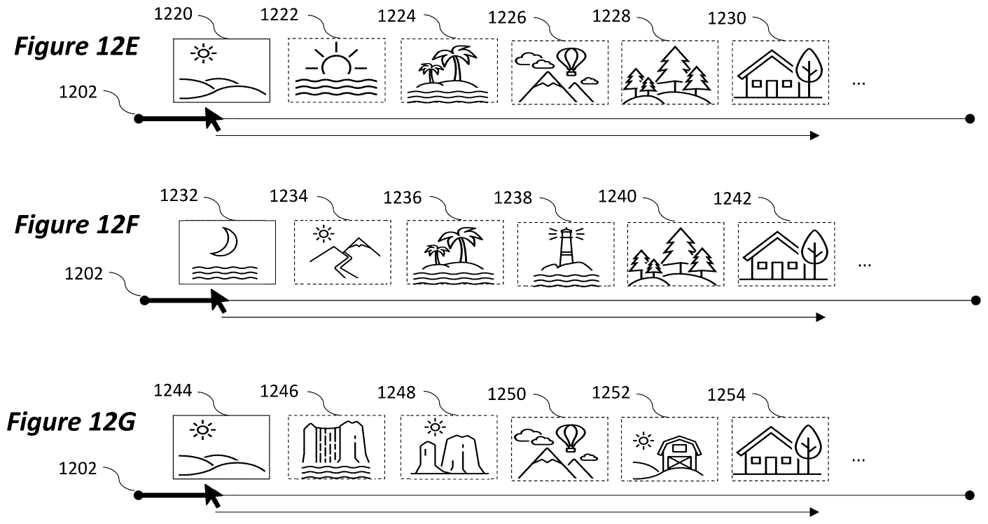

Attention will now be directed to FIGS. 12A-12G, which illustrate a variety of different sets of thumbnails that have been generated and/or modified to provide a customized trick play experience for the user. Initially, FIG. 12A represents an unmodified or non-customized set of thumbnails (e.g., thumbnails 303) that could be generated for a media file (e.g., media file 302) for reference to be compared against other examples of modified/customized thumbnail sets. FIG. 12A illustrates thumbnail 1204, thumbnail 1206, thumbnail 1208, thumbnail 1210, thumbnail 1212, and thumbnail 1214. Attention will now be directed to FIG. 12B, which represents a modified version of the thumbnail set illustrated in FIG. 12A, wherein thumbnail 1206 was identified to comprise targeted content that the user wanted to avoid. The thumbnail set of FIG. 12B was modified by replacing thumbnail 1206 with thumbnail 1216, which is a new thumbnail that was generated in response to identifying the targeted content in thumbnail 1206.

FIG. 12C represents a modified version of the thumbnail set of FIG. 12A, except instead of generating a new thumbnail, thumbnail 1206 is omitted from the trick play display, as indicated by the dotted-line rectangle. In some instances, the system does not display any thumbnail when the cursor hovers at the corresponding location on the video progress bar 1202. Alternatively, the previous thumbnail (e.g., thumbnail 1204) or next thumbnail (e.g., thumbnail 1208) is used to fill in the omitted thumbnail. FIG. 12D represents another example of a modified thumbnail set, wherein thumbnail 1206 is blacked out (e.g., thumbnail 1218), thereby preventing the display of the targeted content and also providing a visual indication to the user that the content for the media file at the temporal location corresponding to the blacked-out thumbnail comprises targeted content.

FIG. 12E represents a universal set of thumbnails (e.g., thumbnail 1220, thumbnail 1222, thumbnail 1224, thumbnail 1226, thumbnail 1228, and thumbnail 1230). This set of universal thumbnails is representative of a filtered set of thumbnails that is obtained by applying a universal filter (e.g., universal filter 402 and/or universal filter 502). Additionally, or alternatively, this set of universal thumbnails is representative of a universally generated set of thumbnails using universal generation criteria 802.

FIG. 12F represents a customized set of thumbnails (e.g., thumbnail 1232, thumbnail 1234, thumbnail 1236, thumbnail 1238, thumbnail 1240, and thumbnail 1242). This set of customized thumbnails is representative of a filtered set of thumbnails that is obtained by applying a user filter (e.g., user filter 602, user filter 604, user filter 608) that is based on filtering criteria included in the user profile that is configured to be applied to any media files that are accessed through that user profile. Additionally, or alternatively, this set of customized thumbnails is representative of a customized set of thumbnails generated from using user-defined profile settings 804.

FIG. 12G represents another example of a customized set of thumbnails (e.g., thumbnail 1244, thumbnail 1246, thumbnail 1248, thumbnail 1250, thumbnail 1252, and thumbnail 1254). This set of customized thumbnails is representative of a filtered set of thumbnails that is obtained by applying a user filter (e.g., user filter 602, user filter 604, user filter 608) that is based on filtering criteria included in the user profile that is configured to be applied to a specific media file. Additionally, or alternatively, this set of customized thumbnails is representative of a customized set of thumbnails generated from using user-defined media file settings 806.

As illustrated in the aforementioned sets of thumbnails, it should be appreciated that in some instances, similar or exact thumbnails may be retained or generated as compared to the original set of unmodified/generic set of thumbnails if the thumbnails did not comprise any targeted content as indicated in any of the filtering/customization settings. Notably, the different sets of customized thumbnails (e.g., as illustrated in FIG. 12E-12G) may also comprise some similar or exact thumbnails to each other, while for other portions of content in the media file, different thumbnails are retained through filtering, modified, or generated for the same portions of content in the media file, in order to provide a customized trick play experience for any of the universal settings, user profile settings, or user media file settings.

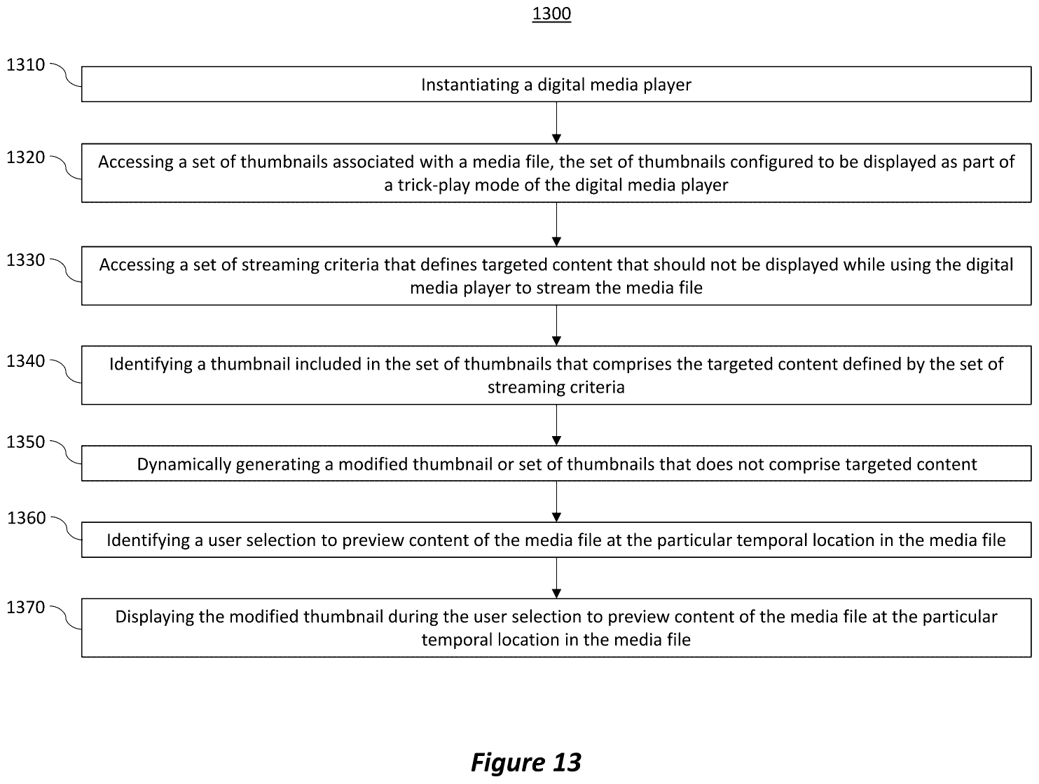

Attention will now be directed to FIG. 13, which illustrates a flowchart of acts (act 1310, act 1320, act 1330, act 1340, act 1350, act 1360, and act 1370) associated with method 1300 that can be implemented by a computing system (e.g., computing system 1500) and is configured for providing a customized trick play experience by modifying an existing set of thumbnails that will be displayed.

A first illustrated act is provided for identifying a triggering event that triggers an activation of a trick play mode of a digital media player (act 1310). In response to identifying the triggering event, systems access a set of thumbnails (e.g., thumbnails 303) associated with a media file (e.g., media file 302) (act 1320). The set of thumbnails is configured to be displayed as part of a trick-play mode (e.g., video progress bar 108) of the digital media player. By accessing a previously generated set of thumbnails, the system is able to adapt/modify existing thumbnails that may have been generated and stored with the media file being accessed. This saves processing time, instead of having to generate an entire new set of thumbnails.

Systems also access a set of streaming criteria (i.e., filtering criteria) that defines targeted content that should not be displayed while using the digital media player to stream the media file (act 1330). By accessing streaming criteria, the system is able to customize the user's experience according to the user's own preferred settings and/or an expected universal setting associated with a positive trick play experience for a plurality of different users. Based on the set of streaming criteria, systems identify the thumbnail included in the set of thumbnails that includes the targeted content defined by the set of streaming criteria (act 1340). The thumbnail is associated with a particular temporal location in the media file. By identifying specific thumbnails that have targeted content, the system is able to take action to modify or replace only those thumbnails in the set of thumbnails that need to be modified or replaced to prevent the user from being exposed to unwanted targeted content.

In response to identifying the thumbnail included in the set of thumbnails that includes targeted content, systems dynamically generate a modified thumbnail or set of thumbnails that does not include targeted content (act 1350). By dynamically generating the modified thumbnail or set of thumbnails, the user is still provided a seamless trick play experience but is now customized without displaying any targeted content. Additionally, systems identify a user selection to preview the content of the media file at the particular temporal location in the media file (act 1360). Finally, in response to identifying the user selection, systems display the modified thumbnail or a temporally relevant thumbnail in the modified set of thumbnails during the user selection to preview the content of the media file at the particular temporal location in the media file (act 1370).

Several different triggering events could be used and/or identified to trigger the activation of the trick play mode of the digital media player. For example, in some instances, the triggering event includes receiving a user request to access or stream a media file using the digital media player. In some instances, the triggering event includes identifying a user selection at a user interface associated with the digital media player for at least one of the following actions: play, pause, fast-forward, rewind, or seek/scroll.

As described earlier in the application, there are many different configurations of streaming criteria that the system is able to access and use to customize the trick play experience, including how to modify the thumbnails to improve the user experience. For example, in some instances, the set of streaming criteria is based at least in part on universal streaming criteria (e.g., universal filter 402 or universal 502) that apply to any media files accessed across all user profiles. In some instances, the set of streaming criteria is based at least in part on user profile settings (e.g., user filter 602, user filter 604, user filter 606) associated with a particular user profile that is applicable to any media files accessed through the particular user profile. In some instances, a user sets each setting manually in their profile. Additionally, or alternatively, the system is configurable to receive user input that is executable to select a group of pre-determined or categorized settings. For example, in some instances, a user may select a particular profile to be a “kids-safe” profile, wherein the “kid-safe” designation automatically selects a predetermined set of streaming criteria. In another example, a user may wish to only view content with ratings at PG-13 or below, wherein the system is able to apply the appropriate streaming criteria to only being able to access media content that is PG-13 or below through that particular user profile.

It should also be appreciated that the user profile settings may also be configured as parental settings that apply to one or more corresponding user profiles. In some instances, the user interface is configured to receive user input that shares settings from one user's profile to another user's profile, wherein the settings are automatically applied or the secondary user is able to select which of the first user's streaming criteria settings will be applied. Additionally, or alternatively, the set of streaming criteria is based at least in part on media file settings (see also, description of user filters in reference to FIG. 6). that apply to a particular media file.

There are many different ways to modify the thumbnail according to the streaming criteria to achieve the customized trick play experience. For example, in some instances, modifying the thumbnail includes replacing the thumbnail with a different thumbnail that does not include targeted content (see, FIG. 12B). In some instances, the thumbnail is replaced with a proximately located thumbnail just before or just after the thumbnail or is replaced with a newly generated thumbnail. In some instances, modifying the thumbnail includes omitting the thumbnail from display during the customized trick play experience (see FIG. 12C), blacking out the thumbnail (see FIG. 12D), and/or dynamically censoring the targeted content in the thumbnail. The targeted content can be dynamically censored by blurring, scrambling, or covering some portion or all of the frame(s) associated with the targeted content.

In order to identify the thumbnails that have targeted content, the system is able to employ a variety of methods to detect the targeted content and flag the corresponding thumbnail for subsequent modification. For example, in some instances, the targeted content is identified by comparing a set of fingerprints (e.g., media file fingerprints 1010 or global fingerprint index 1100) including intrinsic attributes corresponding to the targeted content against the set of thumbnails or by using a set of timestamp-based tags (e.g., tag 904, tag 906, tag, tag 908) associated with the media file (e.g., media file 902).

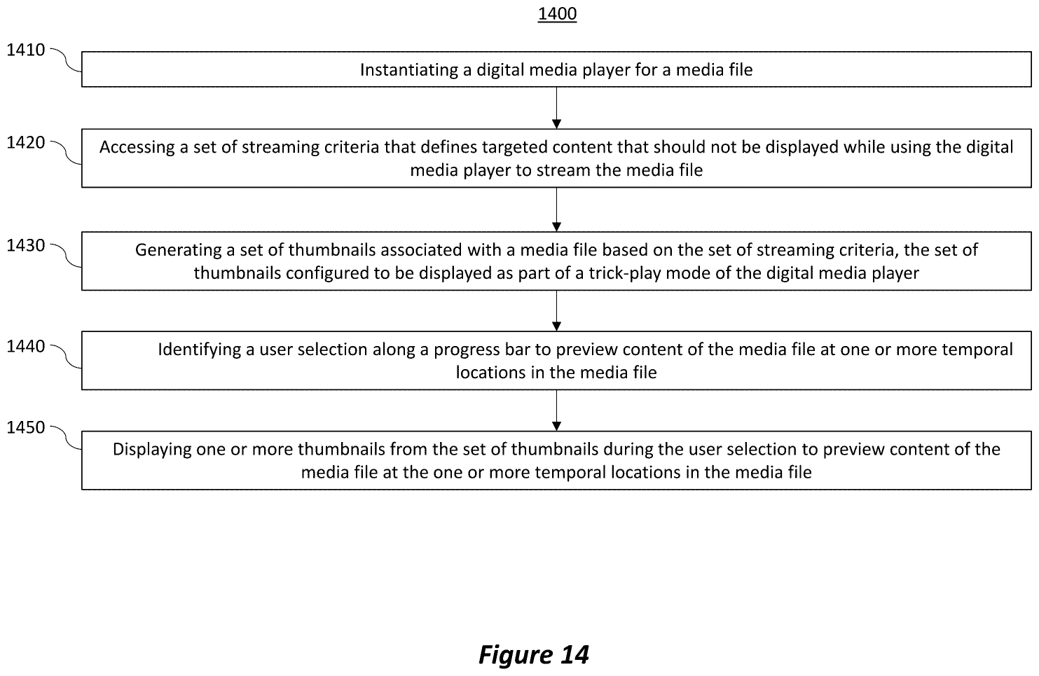

Attention will now be directed to FIG. 14, which illustrates a flowchart of acts (act 1410, act 1420, act 1430, act 1440, and act 1450) associated with method 1400 that can be implemented by a computing system (e.g., computing system 1500) and is configured for providing a customized trick play experience by generating a customized set of thumbnails that will be displayed.

A first illustrated act is provided for identifying a triggering event that triggers the activation of a trick play mode of a digital media player for a media file (act 1410). In response to identifying the triggering event, systems access a set of streaming criteria (e.g., generation criteria 706) that defines targeted content that should not be displayed while using the digital media player to stream the media file (act 1420). By accessing the set of streaming criteria, the system is able to generate thumbnails for the media file based on specific preferred user settings or based on a universal setting configured to provide a broad positive experience for any user. Systems then generate a set of thumbnails (e.g., customized thumbnails 708) associated with a media file (e.g., media file 702) based on the set of streaming criteria (e.g., generation criteria 706) (act 1430). The set of thumbnails is configured to be displayed as part of a trick-play mode of the digital media player (see FIG. 1-2). By generating the set of thumbnails in this manner, the system is able to ensure that every thumbnail in the set of thumbnails that is displayed to the user meets the user's streaming criteria. This may include omitting any objectionable material from being presented within a thumbnail based on the streaming criteria. Additionally, the system is able to dynamically generate the thumbnails in real time if needed in order to provide a seamless, uninterrupted trick play experience for the user. The system is also able to save on long-term storage requirements by generating and caching the thumbnails during the media file access but is able to delete them from the cache when the thumbnails are no longer needed in anticipation of using the trick play functionality of the digital media player.

Systems also identify a user selection along a progress bar to preview the content of the media file at one or more temporal locations in the media file (act 1440). In response to identifying the user selection, systems then display one or more thumbnails from the set of thumbnails during the user selection to preview the content of the media file at the one or more corresponding temporal locations in the media file (see FIGS. 1-2).

It should be appreciated that the system is configured to identify a plurality of different triggering events, which cause the activation of the trick play mode of the digital media player and/or subsequent dynamic generation of thumbnails to be used in the trick play experience. For example, in some instances, the triggering event includes receiving a user request to access or stream a media file using the digital media player. The request to access or stream a media file, in some instances, includes receiving user input that requests a playback manifest, wherein the system will return the playback manifest along with a pre-approved list of assets and corresponding trick play timestamps that can be parsed and used by the media player. Additionally, or alternatively, systems identify a user selection at a user interface associated with the digital media player for at least one of the following media file actions: play, pause, fast-forward, or rewind.

As described herein, there are different streaming criteria that the system is able to use in order to customize the trick play experience and generate thumbnails according to the streaming criteria. It should be appreciated that this streaming criteria is also referred to as filtering and/or generation criteria (e.g., generation criteria 706). For example, in some instances, the set of streaming criteria is based at least in part on universal streaming criteria (e.g., universal generation criteria 802) that apply to any media files accessed across all user profiles. In some instances, the set of streaming criteria is based at least in part on user profile settings (e.g., user-defined profile settings 804) associated with a particular user profile that applies to any media files accessed through the particular user profile. Additionally, or alternatively, the set of streaming criteria is based at least in part on media file settings (e.g., user-defined media file settings 806) that apply to a particular media file.

With regard to the methods described above, in reference to FIGS. 13 and 14, it will be appreciated that various use-cases are enabled. Some non-limiting example scenarios illustrating these use-cases will now be provided.

In a first use-case scenario, a movie undergoes preprocessing that includes generating a set of thumbnail derived images from the movie (e.g., a set of thumbnails comprising 1000 images or another predetermined number of images derived from the movie, based on time, content and/or attributes of the movie). That set of thumbnails (e.g., the 1000 or so images) is then stored in a predetermined storage location for subsequent access and reference during playback of the movie. During the movie playback, when the set of thumbnails are instantiated to facilitate trick-play or other thumbnail functionality (or at an earlier time), the system will apply the filtering criteria associated with a specific viewer that is watching the movie to that stored set of thumbnails (e.g., 1000 thumbnail images) in order to filter out content that is determined to be offensive or otherwise filterable based on the filtering criteria associated with the viewer.

This filtering process may result in the identification of some of the thumbnails from the stored set of thumbnails that are determined to be offensive. During this filtering process, the system can generate a derivative thumbnail manifest that identifies the images that are not offensive and that omits the thumbnails that are determined to be offensive from the saved set of thumbnails. For instance, if 35 of the images in the stored set of thumbnails are considered to be offensive according to the viewer's filtering criteria, the subsequently generated thumbnail manifest would only include or identify 965 images of the original 1000 images from the stored set of thumbnails.

Notably, this subsequent thumbnail manifest can be associated with one or more particular viewer(s) without modifying the underlying 1000 thumbnails generated for the movie. This manifest could then be stored and referenced during any subsequent playback of the move by the relevant viewer(s) to render only the 965 non-offensive thumbnail images of the original set of thumbnails during the movie playback. It will be appreciated, in this regard, that the new thumbnail manifest operates as a separate set of thumbnails that can be used to display a filtered subset of the original stored set of thumbnail images for the movie when the system invokes trick-play or other thumbnail invoking functionality for the relevant viewer(s) associated with the derivative thumbnail manifest.

In a second use-case scenario, the preprocessing of the movie includes real-time filtering of the thumbnail images during generation of the original set of thumbnails (e.g., the original 1000 thumbnail images for a movie). In this scenario, the system ensures that each of the thumbnails in the original set of thumbnails (e.g., all 1000 images) are non-offensive thumbnails. To do this, the system will apply all the movie's objectionable filters for a particular user during the thumbnail generation process so that only non-offensive scenes are used when generating the derivative set of the movie thumbnails associated with that particular user. Then, this pre-censored set of thumbnails can be stored as the base set of thumbnails for that particular user to be referenced during any playback of the movie by that particular user. Importantly, in this scenario, all of the images in the stored set of thumbnail images are free of objectionable content according to that particular user's filtering criteria.

In a third use-case scenario, all thumbnails are generated and presented in real-time during movie playback, without storing a separate set of the thumbnails in a separate database for subsequent reference. In this scenario, like the second scenario described above, the system ensures that all generated thumbnails are free from offensive content based on the application of the filtering criteria for the relevant viewer(s), with no intermediate storage of the thumbnails required.

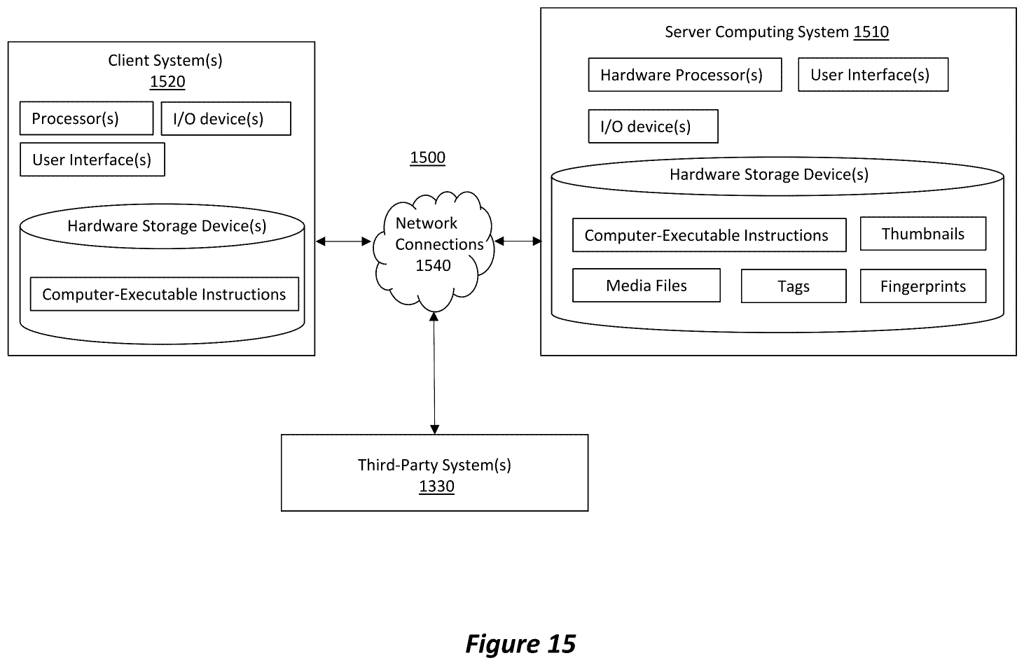

It will be appreciated that many other use-cases are also enabled by the functionality and features of the disclosed systems and methods. Each of these use-cases can be implemented on a computing system, such as described in more detail below with reference to FIG. 15.

### Example Computing Systems

FIG. 15 illustrates an exemplary computing environment 1500 that includes client system(s) 1520 and third-party system(s) 1530 in communication (via a network 1540) with computing system 1510. As illustrated, computing system 1510 is a server computing system configured to compile, modify, and implement a neural transducer configured to perform speech recognition on multi-speaker speech data, including overlapping speech from multiple speakers.

The computing system 1510, for example, includes one or more processor(s) (such as one or more hardware processor(s) and one or more hardware storage device(s) storing computer-readable instructions. One or more of the hardware storage device(s) is able to house any number of data types and any number of computer-executable instructions by which the computing system 1510 is configured to implement one or more aspects of the disclosed embodiments when the computer-executable instructions are executed by the one or more hardware processor(s). The computing system 1410 is also shown including user interface(s) and input/output (I/O) device(s).

As shown in FIG. 15, the hardware storage device(s) is shown as a single storage unit. However, it will be appreciated that the hardware storage device(s) can include a distributed storage that is distributed to several separate and sometimes remote systems and/or third-party system(s). The computing system 1510 can also comprise a distributed system with one or more of the components of computing system 1510 being maintained/run by different discrete systems that are remote from each other and that each performs different tasks. In some instances, a plurality of distributed systems performs similar and/or shared tasks for implementing the disclosed functionality, such as in a distributed cloud environment.

The computing system is in communication with client system(s) 1520 comprising one or more processor(s), one or more user interface(s), one or more I/O device(s), one or more sets of computer-executable instructions, and one or more hardware storage device(s). In some instances, users of a particular software application (e.g., Microsoft Teams) engage with the software at the client system which transmits the audio data to the server computing system to be processed, wherein the predicted labels are displayed to the user on a user interface at the client system. Alternatively, the server computing system is able to transmit instructions to the client system for generating and/or downloading a neural transducer model, wherein the processing of the audio data by the model occurs at the client system.

The computing system is also in communication with third-party system(s). It is anticipated that, in some instances, the third-party system(s) 1530 further comprise databases housing data that could be used as training data, for example, text data not included in local storage. Additionally, or alternatively, the third-party system(s) 1530 includes machine learning systems external to the computing system 1510.

It will be appreciated that the disclosed embodiments may include, be practiced by, or implemented by a computer system (e.g., computing system 1510) that is configured with computer storage that stores computer-executable instructions that, when executed by one or more processing systems (e.g., one or more hardware processors) of the computer system, cause various functions to be performed, such as the acts associated with the various methods recited above.

Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions are physical storage media. Computer-readable media that carry computer-executable instructions are transmission media. Thus, by way of example, embodiments of the disclosure can comprise at least two distinctly different kinds of computer-readable media: physical computer-readable storage media and transmission computer-readable media.

Physical computer-readable storage media includes random access memory (RAM), read-only memory (ROM), electrically erasable programmable ROM (EEPROM), compact disk ROM (CD-ROM), or other optical disk storage (such as compact disks (CDs), digital video disks (DVDs), etc.), magnetic disk storage or other magnetic storage devices, or any other hardware storage devices which can be used to store desired program code in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures and which can be accessed by a general-purpose or special-purpose computer. Combinations of the above are also included within the scope of computer-readable media.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a network interface card (NIC)), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may exist in both local and remote memory storage devices.

Alternatively, or in addition, the functionality described herein can be performed, at least in part, by one or more hardware logic components. For example, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In view of the foregoing, the disclosed embodiments beneficially provide systems and methods for customizing a trick play experience for a user in relation to the use of a digital media player to access and interact with a media file. As described herein, the disclosed embodiments may be utilized to realize many technical benefits and advantages over conventional systems and methods for providing such trick play experiences by allowing users to determine what types of content are included in thumbnails displayed while scrolling through a media file. For example, the disclosed embodiments beneficially provide systems and methods that can customize a trick play mode of a digital media player for different users based on personalized user streaming criteria. In this manner, systems can provide a trick play experience that matches a positive playback or streaming experience associated with a media file in the digital media player.

### CLAUSES

In view of the foregoing description, it will be appreciated that the present invention can also be described in accordance with the following numbered clauses:

Clause 1. A method for providing a customized trick play experience, the method comprising: accessing a set of thumbnails associated with a media file, the set of thumbnails configured to be displayed as part of a trick-play mode of the digital media player; accessing a set of streaming criteria that defines targeted content that should not be displayed while using the digital media player to stream the media file; based on the set of streaming criteria, identifying a thumbnail included in the set of thumbnails that comprises the targeted content defined by the set of streaming criteria, the thumbnail associated with a particular temporal location in the media file; in response to identifying the thumbnail included in the set of thumbnails that comprises targeted content, dynamically generating a modified thumbnail that does not comprise targeted content; identifying a user selection to preview content of the media file at the particular temporal location in the media file; and in response to identifying the user selection, displaying the modified thumbnail during the user selection to preview content of the media file at the particular temporal location in the media file.

Clause 2. The method of clause 1, wherein the accessing the set of streaming criteria that defines targeted content that should not be displayed is performed in response to a user request to access or stream a media file using the digital media player.

Clause 3. The method of clause 1, wherein the accessing the set of streaming criteria that defines targeted content that should not be displayed is performed in response to identifying a user selection at a user interface associated with the digital media player for at least one of the following actions: play, pause, fast-forward, rewind, or seek.

Clause 4. The method of clause 1, wherein the set of streaming criteria is based at least in part on universal streaming criteria that are applicable to any media files accessed across all user profiles.

Clause 5. The method of clause 1, wherein the set of streaming criteria is based at least in part on user profile settings associated with a particular user profile that is applicable to any media files accessed through the particular user profile.

Clause 6. The method of clause 5, wherein the user profile settings are configured as parental settings that apply to one or more corresponding user profiles.

Clause 7. The method of clause 1, wherein the set of streaming criteria is based at least in part on media file settings that apply to a particular media file.

Clause 8. The method of clause 1, wherein modifying the thumbnail includes replacing the thumbnail with a different thumbnail that does not comprise targeted content.

Clause 9. The method of clause 8, wherein the thumbnail is replaced with a proximately located thumbnail just before or just after the thumbnail.

Clause 10. The method of clause 8, wherein the thumbnail is replaced with a newly generated thumbnail.

Clause 11. The method of clause 1, wherein modifying the thumbnail includes omitting the thumbnail from display during the customized trick play experience.

Clause 12. The method of clause 1, wherein modifying the thumbnail includes blacking out the thumbnail.

Clause 13. The method of clause 1, wherein modifying the thumbnail includes dynamically censoring the targeted content in the thumbnail.

Clause 14. The method of clause 1, wherein the targeted content is identified by comparing a set of fingerprints comprising intrinsic attributes corresponding to the targeted content against the set of thumbnails.

Clause 15. A method for providing a customized trick play experience, the method comprising: accessing a set of streaming criteria that defines targeted content that should not be displayed while using the digital media player to stream the media file; generating a set of thumbnails associated with a media file based on the set of streaming criteria, the set of thumbnails configured to be displayed as part of a trick-play mode of the digital media player; identifying a user selection along a progress bar to preview the content of the media file at one or more temporal locations in the media file; and in response to identifying the user selection, displaying one or more thumbnails from the set of thumbnails during the user selection to preview the content of the media file at the one or more temporal locations in the media file.

Clause 16. The method of clause 15, wherein the accessing the set of streaming criteria that defines targeted content that should not be displayed is performed in response to a user request to access or stream a media file using the digital media player.

Clause 17. The method of clause 15, wherein the accessing the set of streaming criteria that defines targeted content that should not be displayed is performed in response to a user selection at a user interface associated with the digital media player for at least one of the following media file actions: play, pause, fast-forward, or rewind.

Clause 18. The method of clause 15, wherein the set of streaming criteria is based at least in part on universal streaming criteria that are applicable to any media files accessed across all user profiles.

Clause 19. The method of clause 15, wherein the set of streaming criteria is based at least in part on user profile settings associated with a particular user profile that applies to any media files accessed through the particular user profile.

Clause 20. The method of clause 15, wherein the set of streaming criteria is based at least in part on media file settings that apply to a particular media file.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed:

1. A method for providing a customized trick play experience, the method comprising:
accessing a set of thumbnails associated with a media file, the set of thumbnails configured to be displayed as part of a trick-play mode of a digital media player;
accessing a set of streaming criteria that defines targeted content that should not be displayed while using the digital media player to stream the media file;
based on the set of streaming criteria, identifying a thumbnail included in the set of thumbnails that comprises the targeted content defined by the set of streaming criteria, the thumbnail associated with a particular temporal location in the media file;
in response to identifying the thumbnail included in the set of thumbnails that comprises targeted content, dynamically generating a modified thumbnail that does not comprise targeted content;
identifying a user selection to preview content of the media file at the particular temporal location in the media file; and
in response to identifying the user selection, displaying the modified thumbnail during the user selection to preview content of the media file at the particular temporal location in the media file.

2. The method of claim 1, wherein the accessing the set of streaming criteria that defines targeted content that should not be displayed is performed in response to a user request to access or stream a media file using the digital media player.

3. The method of claim 1, wherein the accessing the set of streaming criteria that defines targeted content that should not be displayed is performed in response to a user selection at a user interface associated with the digital media player for at least one of the following actions: play, pause, fast-forward, rewind, or seek.

4. The method of claim 1, wherein the set of streaming criteria is based at least in part on universal streaming criteria that are applicable to any media files accessed across all user profiles.

5. The method of claim 1, wherein the set of streaming criteria is based at least in part on user profile settings associated with a particular user profile that are applicable to any media files accessed through the particular user profile.

6. The method of claim 5, wherein the user profile settings are configured as parental settings that apply to one or more corresponding user profiles.

7. The method of claim 1, wherein the set of streaming criteria is based at least in part on media file settings that apply to a particular media file.

8. The method of claim 1, wherein generating the modified thumbnail includes replacing the thumbnail with a different thumbnail that does not comprise targeted content.

9. The method of claim 8, wherein the thumbnail is replaced with a proximately located thumbnail just before or just after the thumbnail.

10. The method of claim 8, wherein the thumbnail is replaced with a newly generated thumbnail.

11. The method of claim 1, wherein modifying the thumbnail includes omitting the thumbnail from display during the customized trick play experience.

12. The method of claim 1, wherein modifying the thumbnail includes blacking out the thumbnail.

13. The method of claim 1, wherein modifying the thumbnail includes dynamically censoring the targeted content in the thumbnail.

14. The method of claim 1, wherein the targeted content is identified by comparing a set of fingerprints comprising intrinsic attributes corresponding to the targeted content against the set of thumbnails.

15. A method for providing a customized trick play experience, the method comprising:
accessing a set of streaming criteria that defines targeted content that should not be displayed while using the digital media player to stream the media file;
generating a set of thumbnails associated with a media file based on the set of streaming criteria, the set of thumbnails configured to be displayed as part of a trick-play mode of the digital media player;
identifying a user selection along a progress bar to preview content of the media file at one or more temporal locations in the media file; and
in response to identifying the user selection, displaying one or more thumbnails from the set of thumbnails during the user selection to preview content of the media file at the one or more temporal locations in the media file.

16. The method of claim 15, wherein said accessing the set of streaming criteria that defines targeted content that should not be displayed is performed in response to a user request to access or stream a media file using the digital media player.

17. The method of claim 15, wherein said accessing the set of streaming criteria that defines targeted content that should not be displayed is performed in response to identifying a user selection at a user interface associated with the digital media player for at least one of the following media file actions: play, pause, fast-forward, or rewind.

18. The method of claim 15, wherein the set of streaming criteria is based at least in part on universal streaming criteria that are applicable to any media files accessed across all user profiles.

19. The method of claim 15, wherein the set of streaming criteria is based at least in part on user profile settings associated with a particular user profile that apply to any media files accessed through the particular user profile.

20. The method of claim 15, wherein the set of streaming criteria is based at least in part on media file settings that apply to a particular media file.
